(19) United States
(12) Patent Application Publication
(10) Pub. No.: US 2025/0246385 A1
(43) Pub. Date: Jul. 31, 2025

(54) Contactor Movable Contact Assembly and Contactor

(71) Applicant: Tyco Electronics (Shanghai) Co., Ltd., Shanghai (CN)

(72) Inventors: Hailin (Timothy) Chen, Shenzhen (CN); Shixiong (Stephen) Cao, Shenzhen (CN)

(73) Assignee: Tyco Electronics (Shanghai) Co., Ltd., Shanghai (CN)

(21) Appl. No.: 19/039,903

(22) Filed: Jan. 29, 2025

(30) Foreign Application Priority Data
Jan. 29, 2024 (CN) 202410124716.6

(51) Int. Cl. H01H 50/64; H01H 50/14; H01H 50/44

(52) U.S. Cl. CPC H01H 50/641; H01H 50/14; H01H 50/44

(57) ABSTRACT

A contactor movable contact assembly includes an installation frame having a magnetic top plate and an insulation bottom seat, a movable terminal movably disposed in the installation frame, a spring disposed in the installation frame, an insulation top seat fixed to the magnetic top plate, an auxiliary movable contact fixed to the insulation top seat, and a drive shaft connected to the insulation bottom seat and driving the installation frame to move. The spring floatably supports the movable terminal. The insulation top seat has a first insulation member and a second insulation member electrically isolating the auxiliary movable contact from the magnetic top plate. The first insulation member has a comparative tracking index lower than a maximum operating voltage allowed by the contactor, and the second insulation member has a comparative tracking index higher than the maximum operating voltage allowed by the contactor.

### CROSS-REFERENCE TO RELATED APPLICATION

This application claims the benefit of the filing date under 35 U.S.C. § 119 (a)-(d) of Chinese Patent Application No. 202410124716.6, filed on Jan. 29, 2024.

### FIELD OF THE INVENTION

The present invention relates to a contactor movable contact assembly and a contactor comprising the contactor movable contact assembly.

### BACKGROUND OF THE INVENTION

In the fields of new energy, such as photovoltaics and energy storage, higher and higher operating voltage requirements are being put forward for the contactors used in them. For example, 2000V or even higher voltages are now being considered rather than the typical 1000V or 1500V. Only ordinary insulation materials are generally used to electrically isolate the low-voltage auxiliary movable contacts from high-voltage components (such as magnetic top plate, movable terminal, and spring) in the auxiliary movable contact assembly. As the working voltage increases, there are higher requirements for insulation distance according to safety regulations, which inevitably requires increasing the internal insulator or designing the insulator with more complex structures to meet the requirements. In this way, the overall volume, manufacturing difficulty, and even cost of the product will significantly increase.

### SUMMARY OF THE INVENTION

A contactor movable contact assembly includes an installation frame having a magnetic top plate and an insulation bottom seat, a movable terminal movably disposed in the installation frame, a spring disposed in the installation frame, an insulation top seat fixed to the magnetic top plate, an auxiliary movable contact fixed to the insulation top seat, and a drive shaft connected to the insulation bottom seat and driving the installation frame to move. The spring floatably supports the movable terminal. The insulation top seat has a first insulation member and a second insulation member electrically isolating the auxiliary movable contact from the magnetic top plate. The first insulation member has a comparative tracking index lower than a maximum operating voltage allowed by the contactor, and the second insulation member has a comparative tracking index higher than the maximum operating voltage allowed by the contactor.

### BRIEF DESCRIPTION OF DRAWINGS

The invention will now be described by way of example with reference to the accompanying figures, of which:

FIG. 1 is a perspective view of a contactor movable terminal assembly according to an exemplary embodiment;

FIG. 2 is an axial sectional view of the contactor movable terminal assembly of FIG. 1;

FIG. 3 is another perspective view of the contactor movable terminal assembly of FIG. 1;

FIG. 4 is an exploded view of the contactor movable terminal assembly of FIG. 1;

FIG. 5 is an exploded sectional view of the contactor movable terminal assembly of FIG. 1; and

FIG. 6 is a perspective view of an insulation bottom seat and a bottom insulation member of the contactor movable terminal assembly of FIG. 1.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth to provide a thorough understanding of the disclosed embodiments. It will be apparent, however, that one or more embodiments may be practiced without these specific details. In other instances, well-known structures and devices are schematically shown to simplify the drawing.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising”, “including”, or “having” an element or a plurality of elements having a particular property may include additional such elements not having that property.

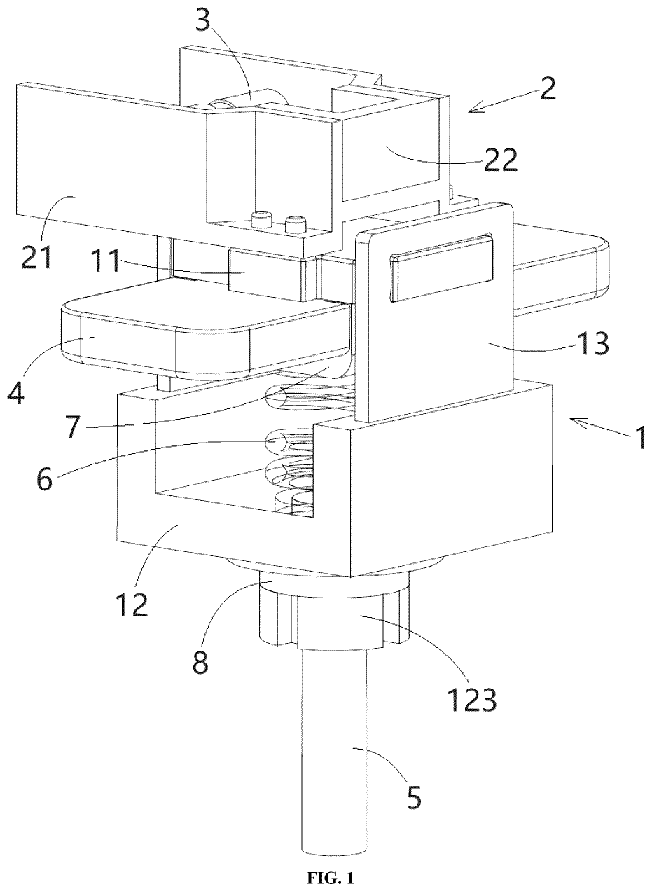

A contactor movable contact assembly according to an exemplary embodiment shown in FIGS. 1-6 is now described. The contactor movable contact assembly comprises an installation frame 1, an insulation top seat 2, an auxiliary movable contact 3, a movable terminal 4, a drive shaft 5, and a spring 6.

The installation frame 1, as shown in FIG. 1, includes a magnetic top plate 11 and an insulation bottom seat 12. The movable terminal 4 is provided in the installation frame 1 for electrical contact with static terminals of the contactor. The spring 6 is installed in the installation frame 1 and floatably supports the movable terminal 4 on the insulation bottom seat 12 of the installation frame 1. The insulation top seat 2 is fixed to a magnetic top plate 11 of the movable terminal 4 or the magnetic top plate 11 of the installation frame 1. In another embodiment, only the installation frame 1 has the magnetic top plate 11. The auxiliary movable contact 3 is fixed to the insulation top seat 2 for electrical contact with an auxiliary static contact of the contactor. The drive shaft 5 is connected to the insulation bottom seat 12 of the installation frame 1, which is used to drive the installation frame 1 to move along the axial direction Z of the drive shaft 5.

As shown in FIG. 1, the insulation top seat 2 is fixed to the magnetic top plate 11 of the installation frame 1. The insulation top seat 2 includes a first insulation member 21 and a second insulation member 22 for electrically isolating the low-voltage auxiliary movable contact 3 from the high-voltage magnetic top plate 11. The comparative tracking index of the first insulation member 21 is lower than the maximum operating voltage allowed by the contactor, and the comparative tracking index of the second insulation member 22 is higher than the maximum operating voltage allowed by the contactor.

As shown in FIG. 1, a second insulation member 22 is added to the first insulation member 21. The comparative tracking index of the second insulation member 22 is higher than the maximum allowable operating voltage of the contactor. Therefore, it is possible to achieve higher electrical insulation performance without increasing the size of the insulation top seat 2, and to safely and reliably isolate the low-voltage auxiliary movable contact 3 from the high-voltage conductive components.

As shown in FIGS. 1-3, a portion of the auxiliary movable contact 3 closest to the magnetic top plate 11 is accommodated in the second insulation member 22 to electrically isolate the portion of the auxiliary movable contact 3 closest to the magnetic top plate 11 from the magnetic top plate 11 by the second insulation member 22.

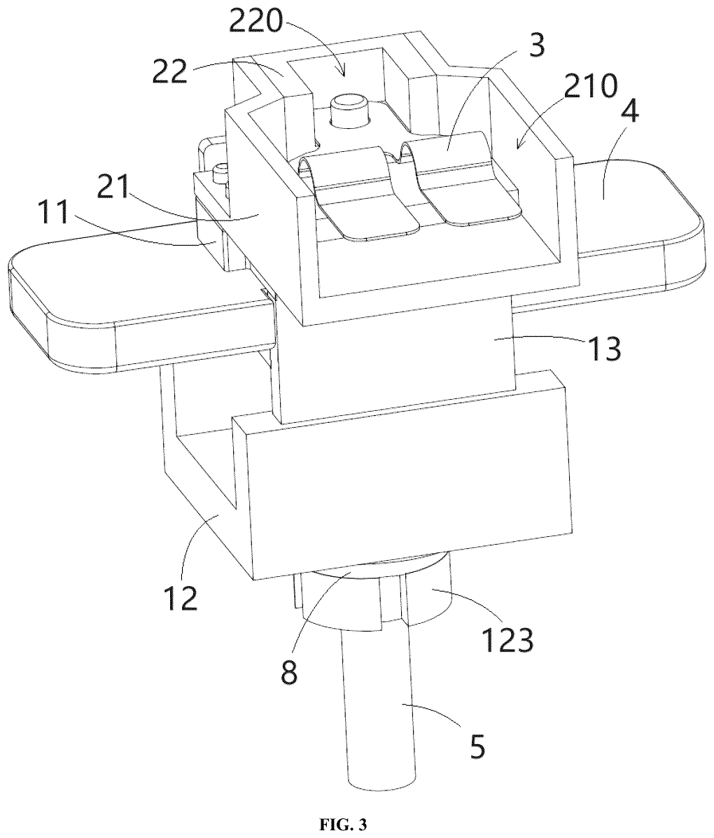

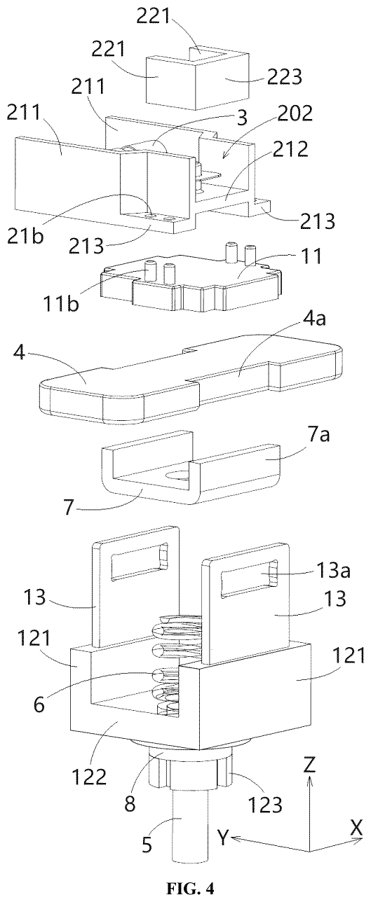

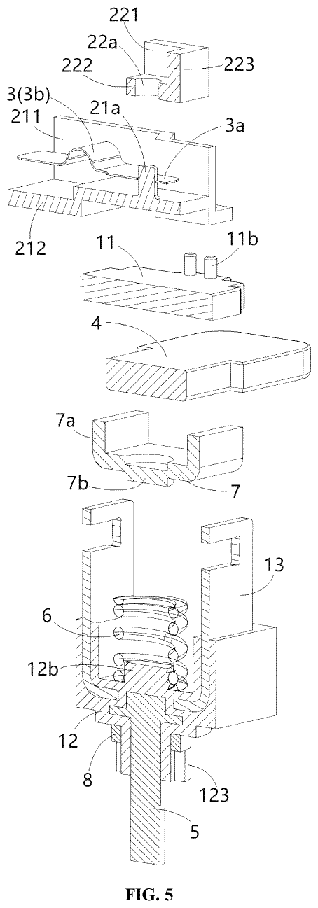

As shown in FIG. 3, the first insulation member 21 has a first accommodating chamber 210, and the auxiliary movable contact 3 and the second insulation member 22 are accommodated in the first accommodating chamber 210 of the first insulation member 21. The first insulation member 21, as shown in FIGS. 4-5, also includes a pair of side plates 211 and a bottom plate 212. The pair of side plates 211 are opposite in the first direction X perpendicular to the axial direction Z of the drive shaft 5. The bottom plate 212 is connected between the bottom of the pair of side plates 211. The first accommodating chamber 210 is defined by the pair of side plates 211 and the bottom plate 212, and the auxiliary movable contact 3 and the second insulation member 22 are fixed to the bottom plate 212.

As shown in FIG. 5, the auxiliary movable contact 3 includes a fixed part 3a fixed to the bottom plate 212 and an elastic portion 3b suspended in the first accommodating chamber 210. The second insulation member 22, as shown in FIG. 3, has a second accommodating chamber 220, and the fixed part 3a of the auxiliary movable contact 3, as shown in FIG. 5, is closest to the magnetic top plate 11 and accommodated in the second accommodating chamber 220.

As shown in FIG. 4, the first insulation member 21 has a first port and a second port 202 opposite each other in a second direction Y perpendicular to the axial direction Z and the first direction X. As shown in FIGS. 3-4, the second insulation member 22 is positioned in the second port 202 of the first insulation member 21 and closes the second port 202. The fixed part 3a of the auxiliary movable contact 3 is positioned in the second accommodating chamber 220 of the second insulation member 22.

As shown in FIGS. 4-5, the second insulation member 22 includes a pair of side walls 221, a bottom wall 222, and an end wall 223. The pair of side walls 221 are opposite in the first direction X. The bottom wall 222 is connected between the bottom of the pair of side walls 221. The end wall 223 is connected between one end of the pair of side walls 221. The second accommodating chamber 220 is defined by the pair of side walls 221, the bottom wall 222, and the end wall 223.

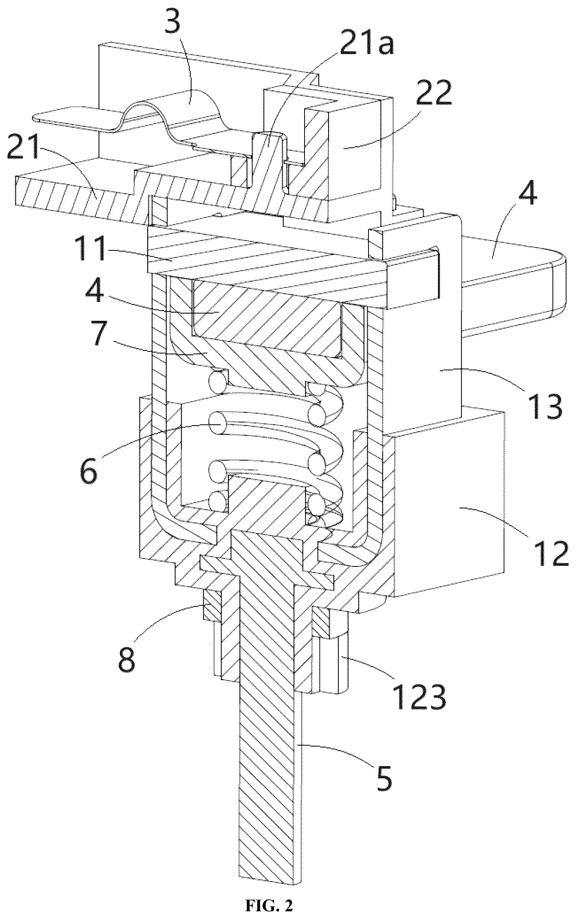

As shown in FIGS. 2 and 5, a positioning post 21a is formed on the inner side of the bottom plate 212 of the first insulation member 21, and positioning holes 22a that cooperate with the positioning post 21a are formed in the bottom wall 222 of the second insulation member 22 and the fixed part 3a of the auxiliary movable contact 3, respectively.

As shown in FIG. 4, the first insulation member 21 has a pair of mounting portions 213 respectively connected to the bottom outer sides of the pair of side plates 211, and mounting holes 21b are formed in the mounting portions 213. On the top surface of the magnetic top plate 11, there is a mounting post 11b corresponding to the mounting hole 21b. The mounting post 11b is inserted into the mounting hole 21b to install the first insulation member 21 onto the magnetic top plate 11.

As shown in FIGS. 1-6, the installation frame 1 further comprises a pair of conductive side plates 13, which are fixed to the insulation bottom seat 12. The magnetic top plate 11 is fixed between the top of the pair of conductive side plates 13. A mounting slot 13a, as shown in FIG. 4, is formed at the top of the conductive side plate 13. As shown in FIG. 2, two ends of the magnetic top plate 11 are respectively inserted into the mounting slots 13a of the pair of conductive side plates 13.

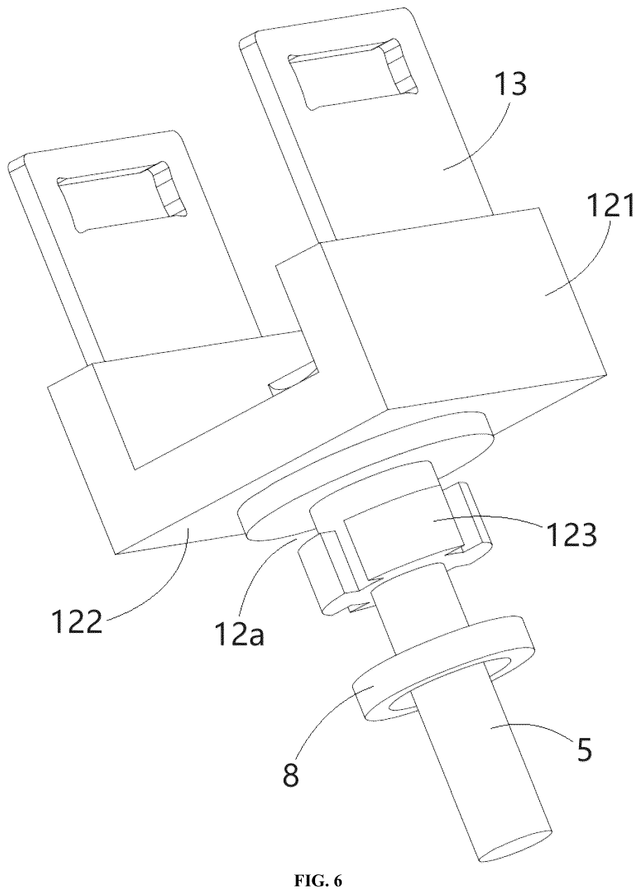

As shown in FIGS. 4 and 6, the insulation bottom seat 12 includes a pair of insulation sidewalls 121 and an insulation bottom wall 122. The insulation bottom wall 122 is connected between the bottom of the pair of insulation sidewalls 121. The lower ends of the pair of conductive side plates 13 are respectively fixed to the pair of insulation sidewalls 121 of the insulation bottom seat 12, and the upper end of the driving shaft 5 is fixed to the insulation bottom wall 122 of the insulation bottom seat 12.

The insulation bottom seat 12, as shown in FIG. 3, is directly formed onto the lower ends of the pair of conductive side plates 13 and the upper end of the drive shaft 5 by an injection molding process, so that the insulation bottom seat 12, the installation frame 1 and the drive shaft 5 are formed into an integral piece.

As shown in FIGS. 1-2 and 4-5, the contactor movable contact assembly further comprises a floatable seat 7. The floatable seat 7 is provided in the installation frame 1 and assembled with the movable terminal 4 to float with the movable terminal 4. The spring 6 is compressed between the floatable seat 7 and the insulation bottom seat 12 to floatably support the floatable seat 7 and the movable terminal 4 on the insulation bottom seat 12.

As shown in FIG. 4, mounting notches 4a are formed on both sides of the movable terminal 4, and mounting flanges 7a are formed on both sides of the floatable seat 7, the mounting flanges 7a are embedded into the mounting notches 4a.

As shown in FIG. 5, a first positioning post 7b is formed on the bottom surface of the floatable seat 7, and a second positioning post 12b is formed on the inner side of the insulation bottom wall 122 of the insulation bottom seat 12. The first positioning post 7b and the second positioning post 12b are axially opposite and respectively inserted into the upper and lower ends of the spring 6 to position the spring 6.

The movable terminal 4, as shown in FIGS. 1-5, is adapted to be moved between a closed position in electrical contact with the static terminal and an open position separated from the static terminal under the drive of the drive shaft 5. The auxiliary movable contact 3 is adapted to be moved between a closed position in electrical contact with the auxiliary static contact and an open position separated from the auxiliary static contact under the drive of the drive shaft 5.

When the movable terminal 4 is moved to the closed position in electrical contact with the static terminal, the auxiliary movable contact 3 is moved to the closed position in electrical contact with the auxiliary static contact. When the movable terminal 4 is moved to the open position separated from the static terminal, the auxiliary movable contact 3 is moved to the open position separated from the auxiliary static contact.

As shown in FIGS. 1-6, the contactor movable contact assembly further comprises a bottom insulation member 8, which is arranged on the bottom of the insulation bottom seat 12 and surrounds the drive shaft 5. The comparative tracking index of the insulation bottom seat 12 is lower than the maximum operating voltage allowed by the contactor, and the comparative tracking index of bottom insulation member 8 is higher than the maximum operating voltage allowed by the contactor.

As shown in FIGS. 1-6, an insulation post 123 is formed on the bottom surface of the insulation bottom wall 122 of the insulation bottom seat 12, and the upper end of the drive shaft 5 is joined into the insulation bottom wall 122 and the insulation post 123 of the insulation bottom seat 12. An annular groove 12a, as shown in FIG. 6, is formed on the insulation post 123 of the insulation bottom seat 12, and the bottom insulation member 8 is annular and engaged into the annular groove 12a on the insulation post 123.

The insulation bottom seat 12, as shown in FIG. 5, is directly formed onto the upper end of the drive shaft 5 by an injection molding process, and the bottom insulation member 8 is directly formed onto the bottom of the insulation bottom seat 12 by a secondary injection molding process.

In another embodiment of the contactor movable contact assembly, the insulation bottom seat 12 and the bottom insulation member 8 are used to electrically isolate the low-voltage drive shaft 5 from the high-voltage conductive components (such as the movable terminal 4, the conductive side plate 13, and the spring 6). Due to the comparative tracking index of the bottom insulation member 8 being higher than the maximum operating voltage allowed by the contactor, it is possible to achieve higher electrical insulation performance without increasing the size of the insulation bottom seat 12, and to safely and reliably isolate the low-voltage drive shaft 5 from the high-voltage conductive components.

A contactor according to an exemplary embodiment of the present invention is now described. The contactor includes a pair of static terminals, a coil, and the contactor movable contact assembly according to FIGS. 1-6. The coil is used to generate an electromagnetic field. The drive shaft 5 is suitable for driving the aforementioned movable terminal 4 from the open position separated from the static terminal to the closed position in electrical contact with the static terminal under the action of electromagnetic force applied by the electromagnetic field.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

1. A contactor movable contact assembly, comprising:
an installation frame having a magnetic top plate and an insulation bottom seat;
a movable terminal movably disposed in the installation frame and electrically contacting a static terminal of a contactor;
a spring disposed in the installation frame, the spring floatably supports the movable terminal on the insulation bottom seat;
an insulation top seat fixed to a magnetic top plate of the movable terminal or the magnetic top plate of the installation frame;
an auxiliary movable contact fixed to the insulation top seat and electrically contacting an auxiliary static contact of the contactor; and
a drive shaft connected to the insulation bottom seat and driving the installation frame to move along an axial direction of the drive shaft, the insulation top seat has a first insulation member and a second insulation member electrically isolating the auxiliary movable contact from the magnetic top plate of the movable terminal or the installation frame, the first insulation member has a comparative tracking index lower than a maximum operating voltage allowed by the contactor, and the second insulation member has a comparative tracking index higher than the maximum operating voltage allowed by the contactor.

2. The contactor movable contact assembly of claim 1, wherein the insulation top seat is fixed to the magnetic top plate of the installation frame, and a portion of the auxiliary movable contact closest to the magnetic top plate is accommodated in the second insulation member to electrically isolate the portion of the auxiliary movable contact closest to the magnetic top plate from the magnetic top plate.

3. The contactor movable contact assembly of claim 2, wherein the first insulation member has a first accommodating chamber, the auxiliary movable contact and the second insulation member are accommodated in the first accommodating chamber.

4. The contactor movable contact assembly of claim 3, wherein the first insulation member has a pair of side plates facing each other in a first direction perpendicular to the axial direction of the drive shaft, and a bottom plate connected between a bottom of each of the pair of side plates, the first accommodating chamber is defined by the pair of side plates and the bottom plate, the auxiliary movable contact and the second insulation member are fixed to the bottom plate.

5. The contactor movable contact assembly of claim 4, wherein the auxiliary movable contact has a fixed part fixed to the bottom plate and an elastic portion suspended in the first accommodating chamber, the second insulation member has a second accommodating chamber, the fixed part of the auxiliary movable contact is closest to the magnetic top plate and accommodated in the second accommodating chamber.

6. The contactor movable contact assembly of claim 5, wherein the first insulation member has a first port and a second port opposite each other in a second direction perpendicular to the axial direction and the first direction, the second insulation member is positioned in the second port of the first insulation member and closes the second port.

7. The contactor movable contact assembly of claim 5, wherein the second insulation member has a pair of side walls facing each other in the first direction, a bottom wall connected between a bottom of each of the pair of side walls, and an end wall connected between an end of each of the pair of side walls, the second accommodating chamber is defined by the pair of side walls, the bottom wall, and the end wall.

8. The contactor movable contact assembly of claim 7, wherein a positioning post is formed on an inner side of the bottom plate of the first insulation member, and a positioning hole cooperating with the positioning post is formed in the bottom wall of the second insulation member and the fixed part of the auxiliary movable contact.

9. The contactor movable contact assembly of claim 4, wherein the first insulation member has a pair of mounting portions respectively connected to a pair of bottom outer sides of the pair of side plates, a mounting hole is formed in each of the pair of mounting portions, and a plurality of mounting posts corresponding to the mounting holes are formed on a top surface of the magnetic top plate, the mounting posts are inserted into the mounting holes to install the first insulation member onto the magnetic top plate.

10. The contactor movable contact assembly of claim 1, wherein the installation frame has a pair of conductive side plates fixed to the insulation bottom seat, the magnetic top plate is fixed between a top of each of the pair of conductive side plates, and a mounting slot is formed at the top of each of conductive side plates, a pair of ends of the magnetic top plate are respectively inserted into the mounting slot of each of the pair of conductive side plates.

11. The contactor movable contact assembly of claim 10, wherein the insulation bottom seat has a pair of insulation sidewalls and an insulation bottom wall connected between a bottom of each of the pair of insulation sidewalls, a lower end of each of the pair of conductive side plates are respectively fixed to the pair of insulation sidewalls of the insulation bottom seat, and an upper end of the drive shaft is fixed to the insulation bottom wall of the insulation bottom seat.

12. The contactor movable contact assembly of claim 10, wherein the insulation bottom seat is directly formed onto a lower end of each of the pair of conductive side plates and an upper end of the drive shaft by embedded injection molding, the insulation bottom seat, the installation frame and the drive shaft are formed into an integral piece.

13. The contactor movable contact assembly of claim 11, further comprising a floatable seat disposed in the installation frame and assembled with the movable terminal to float with the movable terminal, the spring is compressed between the floatable seat and the insulation bottom seat to floatably support the floatable seat and the movable terminal on the insulation bottom seat.

14. The contactor movable contact assembly of claim 13, wherein a pair of installation notches are formed on a pair of sides of the movable terminal, and a pair of installation flanges are formed on a pair of sides of the floatable seat, each installation flange is respectively engaged with one installation notch.

15. The contactor movable contact assembly of claim 13, wherein a first positioning post is formed on a bottom surface of the floatable seat, and a second positioning post is formed on the inner side of the insulation bottom wall of the insulation bottom seat, the first positioning post and the second positioning post are axially opposite and respectively inserted into an upper end and a lower end of the spring to position the spring.

16. The contactor movable contact assembly of claim 1, wherein the movable terminal moves between a closed position in electrical contact with the static terminal and an open position separated from the static terminal under a drive of the drive shaft, and the auxiliary movable contact moves between a closed position in electrical contact with the auxiliary static contact and an open position separated from the auxiliary static contact under the drive of the drive shaft.

17. The contactor movable contact assembly of claim 1, further comprising a bottom insulation member installed on a bottom of the insulation bottom seat and surrounding the drive shaft, a comparative tracking index of the insulation bottom seat is lower than the maximum operating voltage allowed by the contactor, and a comparative tracking index of the bottom insulation member is higher than the maximum operating voltage allowed by the contactor.

18. The contactor movable contact assembly of claim 17, wherein an insulation post is formed on a bottom surface of an insulation bottom wall of the insulation bottom seat, an upper end of the drive shaft is joined into the insulation bottom wall and the insulation post, and an annular groove is formed on the insulation post, the bottom insulation member is annular and engaged into the annular groove on the insulation post.

19. The contactor movable contact assembly of claim 17, wherein the insulation bottom seat is directly formed onto an upper end of the drive shaft by injection molding, and the bottom insulation member is directly formed onto the bottom of the insulation bottom seat by secondary injection molding.

20. A contactor, comprising:
a pair of static terminals;
a coil used to generate an electromagnetic field; and
a contactor movable contact assembly, comprising:
an installation frame having a magnetic top plate and an insulation bottom seat;
a movable terminal movably provided in the installation frame and electrically contacting a static terminal of a contactor;
a spring disposed in the installation frame, the spring floatably supports the movable terminal on the insulation bottom seat;
an insulation top seat fixed to a magnetic top plate of the movable terminal or the magnetic top plate of the installation frame;
an auxiliary movable contact fixed to the insulation top seat and electrically contacting an auxiliary static contact of the contactor; and
a drive shaft connected to the insulation bottom seat and driving the installation frame to move along an axial direction of the drive shaft, the insulation top seat has a first insulation member and a second insulation member for electrically isolating the auxiliary movable contact from the magnetic top plate, the first insulation member has a comparative tracking index lower than a maximum operating voltage allowed by the contactor, and the second insulation member has a comparative tracking index higher than the maximum operating voltage allowed by the contactor, the drive shaft drives the movable terminal from an open position separated from the static terminals to a closed position in electrical contact with the static terminals under an electromagnetic force applied by the electromagnetic field.
